(19) United States
(12) Patent Application Publication
(10) Pub. No.: US 2007/0195291 A1
(43) Pub. Date: Aug. 23, 2007

(54) Projector

(75) Inventor: Toshihiro Tsumura, Osaka (JP)

Correspondence Address: MCDERMOTT WILL & EMERY LLP, 600 13TH STREET, N.W., WASHINGTON, DC, 20005-3096, US

(73) Assignee: TSUMURA RESEARCH INSTITUTE CO.

(21) Appl. No.: 11/709,848

(22) Filed: Feb. 23, 2007

(30) Foreign Application Priority Data
Feb. 23, 2006 (JP) 2006-047122 (P)

(51) Int. Cl. G03B 21/28

(52) U.S. Cl. 353/99

(57) ABSTRACT

A projector includes a light source and a prism total reflection modulator arranged on an optical path of light from the light source and modulating the light with an image signal. The prism total reflection modulator includes a prism having a plane of incidence arranged to allow entrance of light from the light source, and a total reflection surface arranged to totally reflect the light entering from the plane of incidence to a prescribed direction, a plurality of total reflection control elements arranged on the total reflection surface of the prism, for individually controlling whether light is to be totally reflected on the total reflection surface or not, and a driver for individually driving the plurality of total reflection control elements in accordance with the image signal.

### CROSS-REFERENCE TO RELATED APPLICATION

This application claims priority to Japanese Patent Application No. 2006-047122, filed Feb. 23, 2006, and entitled “IMAGE PROJECTING APPARATUS”, which is incorporated herein by reference in its entirety.

### BACKGROUND OF THE INVENTION

1. Field of the Invention

The present invention relates to a projector and, more specifically, to a projector capable of projecting an image of high resolution by effectively utilizing light from a light source.

2. Description of the Background Art

One type of a projector that recently gains wide popularity is a digital projector using a micro mirror display device, referred to as DMD (Digital Micro-mirror Device).

A DMD is an optical device formed by fully utilizing semiconductor technology and, by way of example, it consists of 1280×720 micro-mirrors each allowing independent control, spread over an area of about 1 cm×1 cm to 2 cm×2 cm. Each micro-mirror may assume an attitude of one of two angles, for example, ±12°. Therefore, the attitude of the micro-mirror can be controlled by a digital signal. For instance, if the input digital signal has a value +1, the micro-mirror assumes the attitude of +12°, and if the digital signal has a value 0, the micro-mirror assumes the attitude of −12°. This angle is very accurate, as it is realized by semiconductor technique.

In the array paved with the micro-mirrors, the attitude of each micro-mirror is changed in accordance with a pixel value of an image signal. While light is directed to all micro-mirrors, a mirror assuming the attitude of +12° reflects the light to a prescribed direction and a mirror assuming the attitude of −12° reflects the light to a different direction. When a screen is placed in the prescribed direction, an image corresponding to the original image signals is formed on the screen by the light reflected from the mirrors. Each pixel of the image is formed by each micro-mirror.

To realize gradations, the ratio of time period in which each micro-mirror assumes the angle of +12° per unit time is controlled. As the ratio of time in which the micro-mirror assumes the angle of +12° becomes higher, the corresponding pixel comes to have higher luminance, resulting in a bright point. When the micro-mirror assumes the angle of −12° for the entire unit time, the corresponding pixel will be a dark point. Signals controlling these micro-mirrors are stored in an SRAM (Static Random Access Memory) arranged immediately below the micro-mirrors, and supplied to a driving unit of the micro-mirrors.

There are two main types of methods of forming color images using DMD. The first is a method using a single DMD, and image signals of various colors are projected in a time-divided manner. In this method, it is a common practice to insert a color filter wheel that rotates in synchronization with the image signals in the optical path, so as to generate light's three primary colors in time-divided manner. The second is a method in which the light is divided into light beams of three primary colors using a prism, each color beam is spatially modulated by the DMD that operates in correspondence to the image signals, and finally, the light beams of three primary colors are integrated. The former method is used in a relatively small apparatus, while the latter is used in a large apparatus.

Prior art references related to projectors using DMD include the following. [Patent Document 1] Japanese Patent Laying-Open No. 2005-092206 (FIG. 2) [Non-patent Document 1] O. Shinchi, M. Hayashida, “Digital Micro-mirror Device (DMD) TM”, date of publication unknown (online), Realize Advanced Technology Co. (Searched Feb. 13, 2006) on the Internet (URL:http://www.realize-at.jp/items/bt/112/5/index.html).

In the digital projector using DMD described above, the light used for projecting image signals is reflected by the surface of each micro-mirror in the DMD. The reflectance is high (according to Non-patent Document 1, 90% or higher), and effective area used for reflection is large. As compared with a transmission type apparatus such as a projector using a liquid crystal shutter, optical loss is smaller and hence, brighter image can be realized.

In the digital projector using DMD, however, there is a problem of reflectance of the micro-mirror surface. Though the reflectance is considerably high at present, still higher reflectance is desirable. Since the micro-mirrors are formed utilizing the semiconductor process, however, available materials are limited and hence, there may be difficulties in further improving reflectance.

A further problem experienced in the digital processor using DMD is accuracy in attitude of the micro-mirrors. Though there is no problem as long as the position of DMD is determined with high accuracy when a bright point is projected, the position of light reflected by the DMD would be different from the normal position if the stopper receiving the DMD at a prescribed position has low accuracy, or if dust or the like is deposited on the surface of the stopper, resulting in a disturbed image.

Further, in a digital projector using DMD, separate pixels are drawn by using a large number of micro-mirrors. The micro-mirrors are formed through the semiconductor process, and a metal layer is formed on the surface thereof Variation in finishing may result in variation in the reflectance of micro-mirrors. Variation in the reflectance results in degraded image quality.

### SUMMARY OF THE INVENTION

Therefore, an object of the present invention is to provide a projector having improved image brightness than the conventional apparatus using DMD.

Another object of the present invention is to provide a projector having improved image brightness and less image disturbance than the conventional apparatus using DMD.

A further object of the present invention is to provide a projector having improved image brightness and less image disturbance than the conventional apparatus using DMD, capable of projecting an image with high image quality.

According to a first aspect, the present invention provides a projector, including: a light source; and a prism total reflection modulator arranged on an optical path of light from the light source, modulating the light with an image signal; wherein the prism total reflection modulator includes a prism having a plane of incidence arranged to allow entrance of light from the light source, and a total reflection surface arranged to totally reflect the light entering from the plane of incidence to a prescribed direction, a plurality of total reflection control elements arranged on the total reflection surface of the prism, for individually controlling whether light is to be totally reflected on the total reflection surface or not, and a driver for individually driving the total reflection control elements in accordance with the image signal.

The light beam emitted from the light source enters the prism total reflection modulator through the plane of incidence, passes through the prism, and reaches the total reflection surface. Each of the total reflection control elements arranged on the total reflection surface is individually controlled by the driver, so that an element prevents internal total reflection of the light beam incident on that position by the total reflection surface, while another element allows internal total reflection of the light beam incident on that position by the total reflection surface. Only the totally reflected light beam proceeds to the prescribed direction and forms an image. Therefore, as the total reflection control elements are driven by the driver in accordance with the image signal, an image is formed at a prescribed position. Total reflection by the total reflection surface of a prism realizes reflectance higher than that attained by the reflection surface of a conventional DMD. As a result, a projector having improved image brightness than the conventional apparatus using DMD can be provided.

Preferably, each of the plurality of total reflection control elements includes a micro pixel actuator arranged on the total reflection surface of the prism and having a control surface selectively assuming a first attitude tightly in contact with the total reflection surface and a second attitude forming a prescribed space from the total reflection surface.

The existing technique of micro-mirror device can be utilized for the micro-pixel actuator for controlling total reflection of a prism. Here, the direction of reflection is determined only by the total reflection of the prism, and it is not dependent on the accuracy in controlling the attitude of micro-pixel actuator. The technique of forming the total reflection surface of a prism with high accuracy has been established, and hence, the reflected light proceeds to a prescribed direction with high accuracy. Therefore, a projector having improved image brightness and less image disturbance than the conventional apparatus using DMD can be provided.

The total reflection control elements may be arranged in a matrix on the total reflection surface.

By the total reflection control elements arranged in a matrix, total reflection of individual pixel of image signals represented by pixels arranged in a matrix can be controlled. As a result, a projector is provided that can easily process existing image signals.

More preferably, the prism includes a triangular prism.

The triangular prism can be formed easily, and reflection accuracy of the total reflection surface can be made very high. As a result, a projector having high reflectance and less image disturbance can be provided in an economically advantageous manner.

According to a second aspect, the present invention provides a projector, including: a light source; and prism total reflection modulating means arranged on an optical path of light from the light source, for modulating the light with a prescribed image signal; wherein the prism total reflection modulating means includes a prism having a plane of incidence arranged to allow entrance of light from the light source, and a total reflection surface arranged to totally reflect the light entering from the plane of incidence to a prescribed direction, a plurality of total reflection control elements arranged on the total reflection surface of the prism, for individually controlling whether light is to be totally reflected on the total reflection surface or not, and driving means for individually driving the plurality of total reflection control elements in accordance with the image signal.

According to a third aspect, the present invention provides a method of modulating the light with an image signal in a projector including a light source and a prism total reflection modulator arranged on an optical path of light from the light source, modulating the light with an image signal. The prism total reflection modulator includes: a prism having a plane of incidence arranged to allow entrance of light from the light source, and a total reflection surface arranged to totally reflect the light entering from the plane of incidence to a prescribed direction; a plurality of total reflection control elements arranged on the total reflection surface of the prism, for individually controlling whether light is to be totally reflected on the total reflection surface or not; and a driver for individually driving the plurality of total reflection control elements in accordance with the image signal. The method includes the steps of: emitting light from the light source to the plane of incidence; establishing, in each frame of the image signal, correspondence between a plurality of pixels forming the frame and the plurality of total reflection control elements; and operating the driver such that in each frame of the image signal, whether the light entering the total reflection surface is to be reflected or not is controlled individually in accordance with a pixel value of the pixel having the established correspondence; on each of the plurality of total reflection control elements.

The light beam from the light source enters a prism total reflection modulator through the plane of incidence, and reaches the total reflection surface. Each of the total reflection control element arranged on the total reflection surface is individually controlled by the driver, so that an element prevents internal total reflection of the light beam incident on that position by the total reflection surface, while another element allows internal total reflection of the light beam incident on that position by the total reflection surface. Only the totally reflected light beam proceeds to the prescribed direction and forms an image. Therefore, when the correspondence to the plurality of total reflection control elements is established, an image is formed at a prescribed position by the step in which the driver drives the total reflection control elements in accordance with the pixel values associated by the correspondence. As the light beam is totally reflected internally by the total reflection at the total reflection surface of the prism, reflectance higher than that attained by the reflection surface of the conventional DMD can be realized. As a result, a method can be provided by which the projector is operated to attain improved image brightness than in the conventional apparatus using the DMD.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a main structure of a digital projector 30 in accordance with an embodiment of the present invention.

FIG. 2 is a block diagram of digital projector 30.

FIG. 3 is a rear view of a prism total reflection modulator 46.

FIG. 4 is a plan view of prism total reflection modulator 46.

FIG. 5 is a cross-sectional view illustrating the principle of operation of a DMPA 82.

FIG. 6 is a cross-sectional view illustrating another example of the DMPA.

FIG. 7 is a cross-sectional view illustrating another example of the DMPA.

FIG. 8 is a cross-sectional view illustrating an operation of the DMPA shown in FIG. 7.

### DESCRIPTION OF THE PREFERRED EMBODIMENTS

### First Embodiment

<Structure>

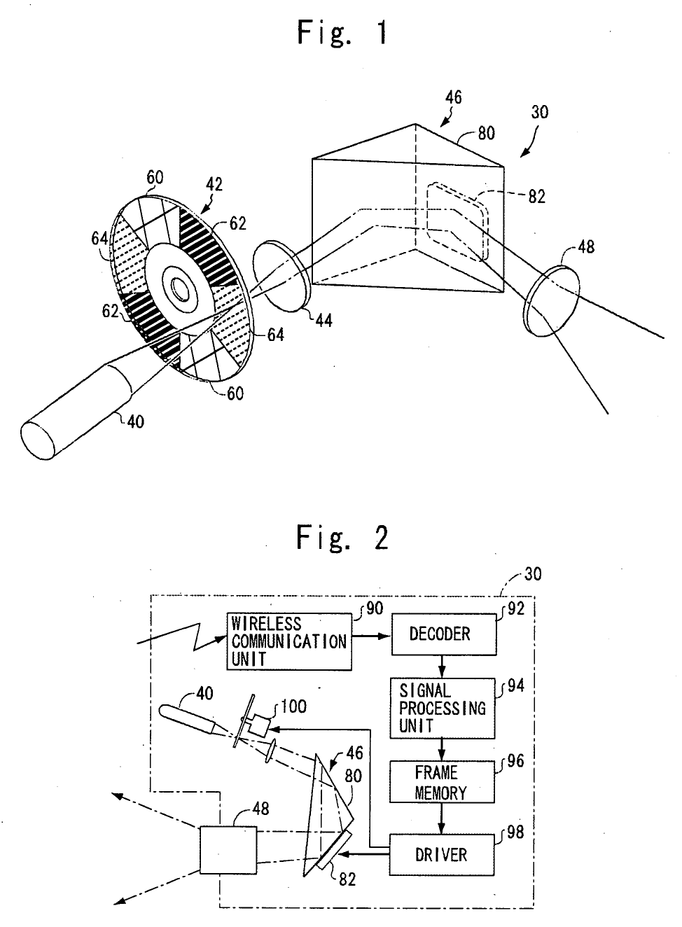

FIG. 1 is a perspective view of a main portion of a digital projector 30 in accordance with the first embodiment of the present invention, and FIG. 2 is a block diagram of digital projector 30, respectively. Though digital projector 30 is capable of projection from video signals, in the following, an example will be described in which digital image signals encoded by a prescribed encoding method from another digital apparatus such as a personal computer are received and projected on a screen.

Referring to FIGS. 1 and 2, digital projector 30 in accordance with the present embodiment uses, in place of the DMD that directly reflects the light from a light source by a micro-mirror, a prism total reflection modulator 46 that controls total reflection of a prism with a digital micro-pixel actuator (hereinafter referred to as a “DMPA”) similar to a DMD, to modulate the light with the image signals. Prism total reflection modulator 46 is arranged on the optical path of the light from the light source. A DMPA operates on a principle similar to that of a DMD, while it differs in that it has a plate referred to as a total reflection control plate, which does not particularly has the function of reflecting light, at the position of the micro-mirror. The total reflection control plate functions as a control surface that controls total reflection of light at the corresponding point.

With reference to FIG. 2, digital projector 30 includes, in addition to prism total reflection modulator 46, a wireless communication unit 90 for receiving digital image signals from another apparatus through wireless communication, a decoder 92 for decoding the digital image signals received by wireless communication unit 90, a signal processing unit 94 for performing digital signal processing such as scaling and gamma correction frame by frame on the image signals output from decoder 92, a frame memory 96 storing image signals output from signal processing unit 94, and a driver 98 for reading the image signals of one frame stored in frame memory 96 and driving the prism total reflection modulator 46.

Scaling refers to a signal processing in which numbers of horizontal and vertical pixels of the input image signals are converted to match the number of pixels of the DMPA used in prism total reflection modulator 46, to establish correspondence between each pixel of the image and each pixel of DMPA. Here, it is assumed that each frame represented by the image signals consists of a plurality of pixels arranged in a matrix, and that pixels of the DMPA are also arranged in a matrix, and a process of calculating the value of each pixel of DMPA from the value of the pixels in each frame represented by the image signals is performed.

Referring to FIGS. 1 and 2, digital projector 30 further includes a light source 40 emitting light to prism total reflection modulator 46, a color filter wheel 42 arranged on the optical path of the light emitted from light source 40, a condenser lens 44 arranged on the optical path between color filter wheel 42 and prism total reflection modulator 46, an optical system 48 for projection arranged on the optical path of the light emitted from light source 40, passed through color filter wheel 42 and condenser lens 44 and reflected by prism total reflection modulator 46, and a motor 100 for rotating color filter wheel 42. Driver 98 has a function of controlling motor 100 to rotate in synchronization with the image signals as well as controlling prism total reflection modulator 46.

Color filter wheel 42 includes, in the present embodiment, filters 60, 62 and 64 of three primary colors, that is, red (R), green (G) and blue (B), respectively. There are two filters prepared for each color, and therefore, there are a total of 6 filters. These filters 60, 62 and 64 are rotated by motor 100, so that the light from light source 40 is turned to color light beams of three primary colors of red, green and blue.

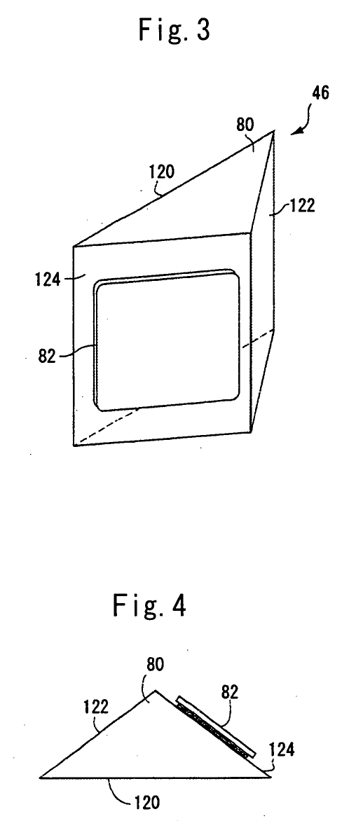

FIG. 3 is a rear view of prism total reflection modulator 46, and FIG. 4 is a plan view of prism total reflection modulator 46, respectively. Referring to FIGS. 1 to 4, prism total reflection modulator 46 includes a prism 80 having the shape of a triangular pole, with two bottom surfaces and three rectangular side surfaces, arranged on the optical path of the light from light source 40. Particularly referring to FIGS. 3 and 4, prism 80 has a plane of incidence 120 to which the light from light source 40 enters, and two total reflection surfaces 122 and 124 formed at an angle for totally reflecting light entering the prism through the plane of incidence 120. The plane of incidence 120 and total reflection surfaces 122 and 124 all constitute side surfaces of the triangular pole of prism 80. On that area of total reflection surface 124 to which the light from total reflection surface 122 enters, a DMPA 82 for individually controlling whether the light entering from the incident surface 122 is to be totally reflected or not by total reflection surface 124 is provided.

Light source 40, condenser lens 44 and prism total reflection modulator 46 are arranged relative to each other in the following manner. Specifically, the light emitted from light source 40 passes through color filter wheel 42 and condenser lens 44 and enters the plane of incidence 120 of prism total reflection modulator 46, and the light is totally reflected by total reflection surface 122 to enter the area of total reflection surface 124 where the DMPA 82 is arranged. If the light were totally reflected by total reflection surface 124, the light passes through the optical system 84 for projection and proceeds in a prescribed direction, and-is projected on a prescribed plane of projection (not shown).

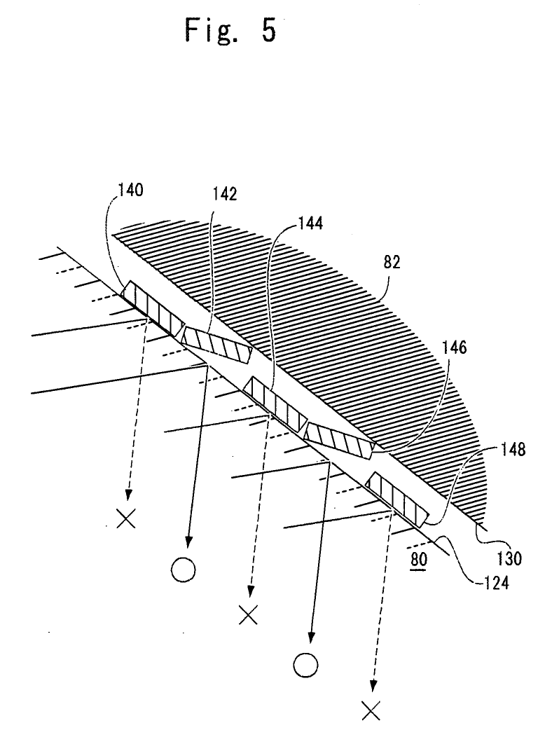

FIG. 5 shows, in enlargement, a cross-section near an interface between total reflection surface 124 and a surface 130 on which the total reflection control plates of DMPA 82 are arranged (hereinafter the surface will be referred to as an “active surface”). “Referring to FIG. 5, on active surface 130 of DMPA 82, a number of total reflection control plates 140, 142, 144, 146 and 148 are arranged in a matrix, in the similar manner as micro-mirrors of the conventional DMD. Each of the total reflection control plates 140, 142, 144, 146 and 148 can be controlled independently as in the case of micro-mirrors of the conventional DMD described above, and in accordance with a control signal applied from a driver 98, the plate assumes either of ±12° from a reference position. In the present embodiment, when the total reflection control plate assumes the position of −12°, the surface that corresponds to the reflection surface of the micro-mirror (hereinafter referred to as a “control surface”) comes into tight contact with total reflection surface 124, and when it assumes the position of +12°, the control surface assumes an attitude forming an angle of 24° with respect to the total reflection surface 124. Specifically, the control surface of total reflection control plate may selectively assume a first attitude at which the control surface is in tight contact with total reflection surface 124, and a second attitude at which the control surface forms an angle of 24° with respect to total reflection surface 124 and thus forming a space of a prescribed size or larger from total reflection surface 124.

In the example shown in FIG. 5, total reflection control plates 140, 144 and 148 are at the former position (−12°), and total reflection control plates 142 and 146 are at the latter position (+12°).

Referring to FIG. 5, it is generally known in connection with total reflection surface of a prism that total reflection does not occur when something is in tight contact with total reflection surface 124, and total reflection occurs when there is a space, because of difference in refractive indices. Therefore, in the example shown in FIG. 5, as the control surfaces of total reflection control plates 140, 144 and 148 are in tight contact with total reflection surface 124, total reflection does not occur at these positions, and as a space exists between the control surfaces of total reflection control plates 142 and 146 and total reflection surface 124, total reflection occurs.

Specifically, each total reflection control plate serves as an element that individually control whether the light beam representing each pixel on total reflection surface 124 is to be totally reflected or not.

In the present embodiment, not the reflection of light on the control surface of DMPA 82 but whether the light is to be totally reflected or not at the total reflection surface 124 of prism 80 is controlled on the control surface of DMPA 82, so that the brightness of the corresponding pixel is determined, as described above. Naturally, by controlling the ratio of time period in which the total reflection control plate is away from total reflection surface 124 per unit time in time-divided manner, the luminance of the corresponding pixel can be adjusted, and images with gradations can be projected. Further, by controlling tones of three primary colors in the time-divided manner using color filter wheel 42 (see FIG. 1), respectively, color images can be projected.

<Operation>

The digital projector 30 described above operates in the following manner. Referring to FIGS. 1 to 5, the light emitted from light source 40 enters the filter portion of color filter wheel 42. Color filter wheel 42 is controlled by driver 98 such that it rotates in synchronization with a frame signal of the image signals. By way of example, color filter wheel 42 is set to rotate 6 times per 1 frame of the image signals. With color filter wheel 42 set at such rotation speed, it follows that the piece of information for each color is projected in a dispersed manner, that is, 12 times per 1 frame. Therefore, it is possible to prevent misperception of specific color information as the specific color is missing, by the user while he/she blinks, can be prevented.

The light that has passed through color filter wheel 42 passes through condenser lens 44 and enters through the plane of incidence 120 of prism total reflection modulator 46 (see FIGS. 3 and 4) to the prism 80 of prism total reflection modulator 46. Further, the light is totally reflected internally by total reflection surface 122, and enters the area of total reflection surface 124 on which DMPA 82 is provided.

Driver 98 shown in FIG. 2 controls the ratio of time period in which each total reflection control plate of DMPA 82 is in tight contact with total reflection surface 124 in accordance with the gradation of each component of R, G and B primary colors of the image signals. When total reflection control plate is away from total reflection surface 124, the light is totally reflected internally at total reflection surface 124 at that point, and projected to the plane of projection through optical system 48 for projection. When the total reflection control plate is brought into tight contact with total reflection surface 124, the light is not totally reflected at that point. Therefore, the light does not reach the plane of projection. In this manner, gradation control is realized in the time-divided manner by prism total reflection modulator 46 for each component of three primary colors, that is, R, G and B. It follows that the image signals of R, G and B are projected in the time-divided manner on the plane of projection, which are perceived by human eyes as sufficiently mixed color images.

<Conclusion>

As described above, by the present embodiment, rather than reflecting projection light directly by DMD, whether the light is to be totally reflected or not at the total reflection surface of a prism is controlled by the DMPA. There have been accumulated techniques that enable highly accurate finish of a total reflection surface of a prism. Though control of total reflection of light at the total reflection surface is realized by the DMPA, the control may be done in a digital manner, that is, 1 or 0. Even when the accuracy of DMPA attitude itself is not very high, its influence on the total reflection control by the present technique is insignificant. Therefore, as compared with an apparatus in which the light is directly reflected by the DMD, projection with higher accuracy becomes possible.

Further, in digital projector 30, the light is totally reflected by the total reflection surface of prism 80. The reflectance is higher than when the light is directly reflected by the DMD, and position-to-position variation in reflectance is smaller. Further, as the most part of the total reflection surface can be used as the reflection surface, optical loss is small. As a result, images that is brighter and of higher contrast can be projected with high image quality.

In the embodiment described above, the number of light reflection is twice, and hence, optical loss along the optical path can be made smaller than in the example of Patent Document 1, for example, in which a number of prisms and splitters are used. Therefore, it becomes possible to project bright images with high light intensity, effectively utilizing the light from light source 40. From the same reasons, it is possible to lower cost.

In the embodiment above, digital projector 30 has been described in which modulation of three primary colors is performed in the time-divided manner using a color filter wheel. The present invention, however, is not limited thereto. The light may be divided into three primary colors, modulation is done by prism total reflection modulator 46 described above on each primary color, and the modulated light beams may be integrated to form the color image.

As light source 40, a general halogen light source or an LED (laser diode) may be used.

Though prism 80 having the shape of a triangular pole has been used in the embodiment above, the present invention is not limited thereto. Any prism may be used, provided that optical paths of incoming and outgoing light beams do not overlap. Further, though the optical path is on one plane in the embodiment above, the optical path may be a three-dimensional path.

Prism total reflection modulator 46 described with reference to the embodiment above may be used directly in place of the DMD in a conventional projector using DMD. Though the position of arrangement must be altered from that of DMD, it does not require any major modification in other respects. Therefore, a projector of higher performance can be provided while effectively making use of the conventional technique. Further, as the total reflection control plates of the DMPA are arranged in a matrix, image signals consisting of pixels arranged in a matrix can be represented in a simple manner.

Further, in the embodiment above, as the element for controlling total reflection, DMPA similar to DMD is used. This is also advantageous in that the conventional technique can be effectively used. The present invention, however, is not limited to such an embodiment. By way of example, the following structure may be available.

On the total reflection surface, partitions may be provided for each pixel, to from a plurality of pixel cells. Liquid of high surface tension may fill each cell. On the rear surface of the pixel (the surface opposite to the total reflection surface, with the pixel being the center), piezo elements or the like are arranged. When the liquid is pressed onto the total reflection surface using the piezo element, contact area between the liquid and the total reflection surface increases. When the pressing force is removed, the contact area becomes smaller. As a result, it becomes possible to control total reflection pixel by pixel.

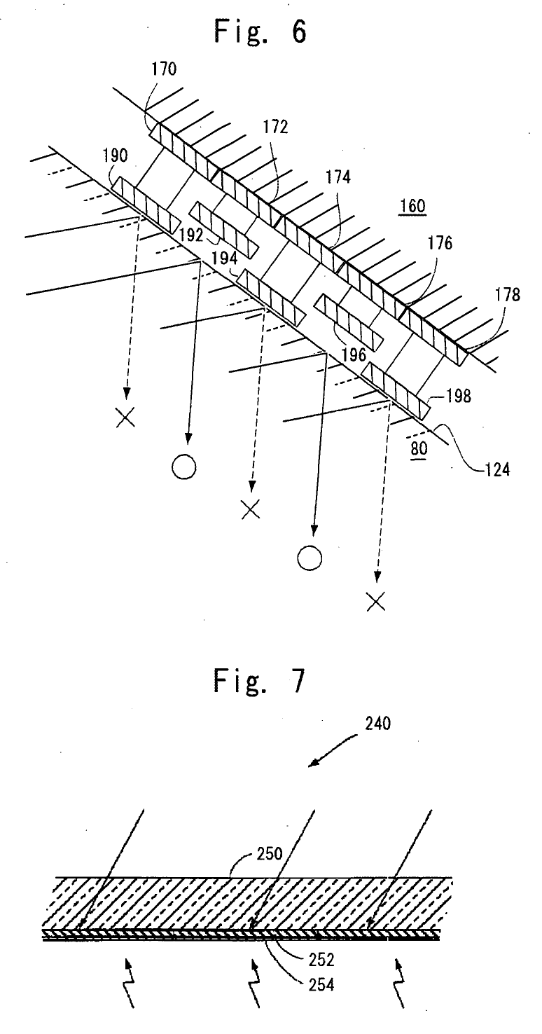

FIG. 6 shows a further example of the DMPA. DMPA 160 of FIG. 6 includes a plurality of total reflection control plates 190, 192, 194, 196 and 198 arranged in a matrix on total reflection surface 124 of prism 80, and micro-actuators 170, 172, 174, 176 and 178, for separating each of the total reflection control plates 190, 192, 194, 196 and 198 from or bringing each of these plates into contact with, total reflection surface 124.

Total reflection control plates 190, 192, 194, 196 and 198 are controlled individually by micro-actuators 170, 172, 174, 176 and 178, respectively. By such an arrangement, it becomes possible to control whether the light reaching the total reflection surface 124 should be totally reflected or not at positions of total reflection control plates 190, 192, 194, 196 and 198, in the similar manner as in the embodiment described above.

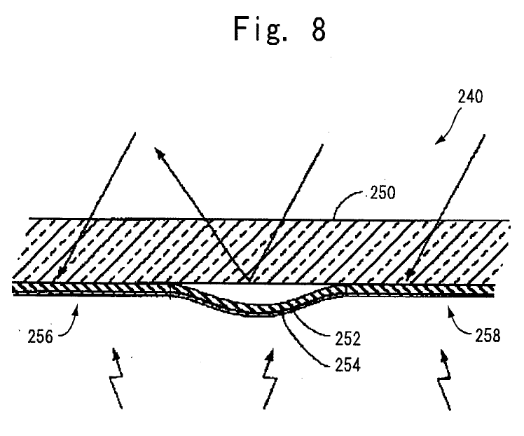

FIGS. 7 and 8 show a further example of the DMPA. DMPA 240 shown in FIGS. 7 and 8 adopts a micro-actuator that is controlled not electrically but optically. When a material having a characteristic that deforms when irradiated with light, such as a polymer called polydiacetylene is used, an actuator of high response can be realized.

FIG. 7 is a cross-sectional view of DMPA 240 including such an optically controlled micro-actuator. Referring to FIG. 7, the micro-actuator is arranged on the total reflection surface of a prism 250 constituting the prism total reflection modulator, and it includes: a total reflection control body 252, which is thin and slightly elastic, formed of a material of higher density than prism 250 and arranged to be in tight contact with the total reflection surface of prism 250 in a normal state; and a thin film 254 of polydiacetylene mentioned above, adhering to a surface opposite to the surface in contact with prism 250, of total reflection control body 252. Total reflection control body 252 is adhered to the total reflection surface of prism 250 at its peripheral edge portions. As total reflection control body 252, one having such elasticity is used that allows tight contact with the total reflection surface of prism 250 and generates, with the total reflection surface, a space of such a size that hinders total reflection when deformed, as will be described later.

As shown in FIG. 7, in the first state, total reflection control body 252 is in tight contact with the total reflection surface of prism 250. Therefore, the light entering prism 250 is not totally reflected by the total reflection surface of prism 250. Specifically, the light from this portion does not reach the plane of projection.

Polydiacetylene is known to have such a characteristic that when irradiated with light having the wavelength of 450 to 550 nanometer, its volume increases about 3%, and returns to the original volume when irradiated with light having the wavelength of 350 to 400 nanometer.

Therefore, in the state of FIG. 7, total reflection control body 252 corresponding to a portion at which total reflection is desired is irradiated with light having the wavelength of 450 to 550 nanometer. At such a portion, polydiacetylene thin film 254 comes to have increased volume, resulting in a space from the total reflection surface of prism 250, as shown at the central portion of FIG. 8. Therefore, the light entering such a portion of total reflection control body 252 is totally reflected.

On the other hand, total reflection control body 252 corresponding to a portion at which total reflection is not desired is irradiated with light having the wavelength of 350 to 400 nanometer. Then, as shown at the left and right portions of FIG. 8, polydiacetylene thin film 254 comes to have decreased volume, and as a result, total reflection control body 252 deforms to be in tight contact with glass surface 250. Therefore, the light entering the total reflection surface of prism 250 is not totally reflected at these areas 256 and 258 of total reflection control body 252.

When the total reflection control body is driven by a substance having the characteristic of optical deformation as described above, response can be improved and the structure can be made relatively simple. Further, as the total reflection control body is driven optically, interconnections for driving the total reflection control body with electric signals becomes unnecessary. Therefore, the size of the apparatus can further be reduced, and a projector capable of projecting images with high density can be realized.

In the embodiments described above, the total reflection control plate does not have the function of reflecting light. As is apparent from the description above, whether or not the total reflection control plate has such a function is not important. For instance, a control plate having the reflecting function may be used, as in the conventional DMD.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. A projector, comprising:
a light source; and
a prism total reflection modulator arranged on an optical path of light from said light source, modulating said light with an image signal; wherein
said prism total reflection modulator includes
a prism having a plane of incidence arranged to allow entrance of light from said light source, and a total reflection surface arranged to totally reflect the light entering from said plane of incidence, to a prescribed direction,
a plurality of total reflection control elements arranged on said total reflection surface of said prism, for individually controlling whether light is to be totally reflected on said total reflection surface or not, and
a driver for individually driving said plurality of total reflection control elements in accordance with the image signal.

2. The projector according to claim 1, wherein
each of said plurality of total reflection control elements includes a micro pixel actuator arranged on said total reflection surface of said prism and having a control surface selectively assuming a first attitude tightly in contact with said total reflection surface and a second attitude forming a prescribed space from said total reflection surface.

3. The projector according to claim 2, wherein
said plurality of total reflection control elements are provided such that said control surfaces are arranged in a matrix on said total reflection surface.

4. The projector according to claim 3, wherein
each frame of said image signal is represented by a plurality of pixels arranged in a matrix; and
said driver drives said micro pixel actuator in accordance with a pixel value of the pixel corresponding to the position on said matrix of the control surface of said micro pixel actuator, in each frame of said image signal.

5. The projector according to claim 4, wherein
said pixel value is a digital value assuming either a first value or a second value; and
said driver drives said control surface of said micro pixel actuator to said first attitude when said digital value is said first value, and drives said control surface of said micro pixel actuator to said second attitude when said digital value is said second value.

6. The projector according to claim 1, wherein
said prism includes a prism having a triangular pole shape.

7. The projector according to claim 6, wherein
said prism of triangular pole shape has first to third rectangular side surfaces and first and second triangular bottom surfaces,
said plane of incidence is said first side surface, and
said total reflection surface is said second side surface.

8. The projector according to claim 1, wherein
said plurality of total reflection control elements are provided such that said control surfaces are arranged in a matrix on said total reflection surface.

9. The projector according to claim 8, wherein
each frame of said image signal is represented by a plurality of pixels arranged in a matrix; and
said driver drives said total reflection control element in accordance with a pixel value of the corresponding pixel.

10. A projector, comprising:
a light source; and
prism total reflection modulating means arranged on an optical path of light from said light source, for modulating said light with a prescribed image signal; wherein
said prism total reflection modulating means includes
a prism having a plane of incidence arranged to allow entrance of light from said light source, and a total reflection surface arranged to totally reflect the light entering from said plane of incidence, to a prescribed direction,
a plurality of total reflection control elements arranged on said total reflection surface of said prism, for individually controlling whether light is to be totally reflected on said total reflection surface or not, and
driving means for individually driving said plurality of total reflection control elements in accordance with the image signal.

11. The projector according to claim 10, wherein
each of said plurality of total reflection control elements includes a micro pixel actuator arranged on said total reflection surface of said prism and having a control surface selectively assuming a first attitude tightly in contact with said total reflection surface and a second attitude forming a space from said total reflection surface.

12. The projector according to claim 10, wherein
said prism includes a prism having a triangular pole shape.

13. In a projector including a light source and a prism total reflection modulator arranged on an optical path of light from said light source, modulating said light with an image signal, a method of modulating said light with an image signal; wherein
said prism total reflection modulator includes: a prism having a plane of incidence arranged to allow entrance of light from said light source, and a total reflection surface arranged to totally reflect the light entering from said plane of incidence to a prescribed direction; a plurality of total reflection control elements arranged on said total reflection surface of said prism, for individually controlling whether light is to be totally reflected on said total reflection surface or not; and a driver for individually driving said plurality of total reflection control elements in accordance with the image signal;
said method comprising the steps of:
emitting light from said light source to said plane of incidence;
establishing, in each frame of the image signal, correspondence between a plurality of pixels forming the frame and said plurality of total reflection control elements; and
operating said driver such that in each frame of the image signal, whether the light entering said total reflection surface is to be reflected or not is controlled individually in accordance with a pixel value of the pixel having the established correspondence, on each of said plurality of total reflection control elements.

14. The method according to claim 13, wherein
each of said plurality of total reflection control elements includes a micro pixel actuator arranged on said total reflection surface of said prism and having a control surface selectively assuming a first attitude tightly in contact with said total reflection surface and a second attitude forming a prescribed space from said total reflection surface; and
said step of operating said driver includes the step of
controlling said control surface of said micro pixel actuator either to said first attitude or to said second attitude, in accordance with the pixel value of the pixel having the established correspondence to the micro pixel actuator, on each of said plurality of micro pixel actuators.
